(19) United States
(12) Patent Application Publication
(10) Pub. No.: US 2002/0138308 A1
(43) Pub. Date: Sep. 26, 2002

(54) Insurance task processing method, insurance task processing program, computer-readable storage medium recorded with insurance task processing program, and insurance task processing system

(75) Inventors: Hiroaki Harada, Kawasaki (JP); Yoshihisa Takayama, Kawasaki (JP); Yoshiyuki Ikeda, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/910,716

(22) Filed: Jul. 24, 2001

(30) Foreign Application Priority Data
Mar. 22, 2001 (JP) 2001-083594

(51) Int. Cl. G06F 17/60

(52) U.S. Cl. 705/4

(57) ABSTRACT

An insurance task processing method, an insurance task processing program, a computer-readable recording medium recorded with the insurance task processing program, and an insurance task processing system, for recommending a subscription to insurance during transactions in the electronic commerce while enabling to objectively prove an occurrence of accident, to thereby protect transaction-involved parties.

### FIELD OF THE INVENTION

The present invention relates to a technique for protecting transaction-involved parties, when conducting electronic commerce making use of computer networks such as the Internet.

### RELATED ART OF THE INVENTION

Recently, there has been extensively utilized the electronic commerce for trading commercial products via computer networks such as the Internet. In the electronic commerce, transactional fellows are frequently anonymous, thereby causing a possibility of troubles such as by cheat or fraud if the transactional fellows act in bad faith. Further, even when the transactional fellows act in good faith, there may be caused accidents such as fracture of commercial products or loss of order slips in the delivery route and the payment route of money, respectively. As such, there have been provided insurance systems by insurers, so as to compensate for losses caused in the electronic commerce. Such insurance systems require that insurance contracts corresponding to the estimated accidental items are to be made before conducting the electronic commerce.

However, only a small number of persons have subscribed to the conventional insurance systems, because of the large number of transactions each involving a small amount of transaction value in the electronic commerce. It has been also complicated to subscribe to the conventional insurance systems, because of the transactional fellows and/or transaction details, which are different from one another, in the electronic commerce.

Meanwhile, in order to compensate for the loss caused in the electronic commerce for, it is required to objectively prove the occurrence of an accident, similarly to the conventional automobile insurance systems. However, actual conditions of transactional fellows are often unknown in the electronic commerce, thereby resulting in difficulty in objectively proving the accident based on the allegations of both of involved parties. In this concern, there has been proposed such an idea to establish an “electronic notarizing system” for rendering the faculties of actual notary offices to be realized on networks, so as to objectively prove the occurrence of an accident in the electronic commerce. However, such an electronic notarizing system is also inappropriate for the electronic commerce, since the system aims at notarizing important transactions involving a large amount of money and requires strict procedures whereas transactions each involving a small amount of transaction value are frequently conducted in the electronic commerce.

Thus, transaction-involved parties in the electronic commerce have not subscribed to insurance systems, in many cases. Further, even if they have subscribed to the insurance systems, it has been practically impossible to objectively prove the occurrence of an accident. This leads to a great possibility that the caused loss is not compensated for, thereby resulting in insufficient protection from an accident.

In view of the conventional problems as described above, it is therefore an object of the present invention to provide an insurance task processing technique for objectively proving the occurrence of an accident while recommending a subscription to insurance during transactions in the electronic commerce, to thereby protect transaction-involved parties.

### SUMMARY OF THE INVENTION

Thus, to recommend a subscription to insurance during transactions in the electronic commerce, the insurance task processing technique according to the present invention is characterized in that electronic information distributed within a computer network is monitored, and that solicitation-to-insurance information is distributed to at least one of involved parties having exchanged the electronic information with each other, when a solicitation-related keyword as a clue of solicitation-to-insurance is included in the electronic information.

According to such a constitution, the solicitation-to-insurance information is distributed to at least one of the involved parties having exchanged the electronic information with each other, when the solicitation-related keyword as a clue of solicitation-to-insurance is included in the electronic information distributed within the computer network. This allows the involved party to reconfirm a risk when conducting a transaction in the electronic commerce. Further, with a simple operation, a subscription applying screen for an insurance item is displayed, by burying a piece of link information to the subscription applying screen in the solicitation-to-insurance information. Thus, the involved party is possible to subscribe to the due insurance with a simple operation during the transaction in the electronic commerce, so that the involved party is protected.

At this time, if the solicitation-to-insurance information is to be distributed to the involved party who has not yet subscribed to insurance, no pieces of solicitation-to-insurance information are distributed to those transaction-involved parties who have already subscribed to the insurance, to thereby avoid such a situation that the latter transaction-involved parties feel annoyed. Further, in a case where the insurance is invalid even when the involved party has already subscribed to insurance, or in a case where the involved party has experienced an encounter with an accident related to the electronic commerce in the past, if the solicitation-to-insurance information is to be distributed to such an involved party preferentially to the other involved parties, the involved party aware of the necessity of insurance is possible to reconfirm the risk in the electronic commerce. Moreover, if the solicitation-to-insurance information from an insurer selected corresponding to the contents of the electronic information is to be distributed, a subscription to such insurance unsuitable for the transaction details can be avoided so that the object of the present invention can be achieved.

Here, it is preferable to receive an insurance premium which has been calculated corresponding to the trading price, based on a discount insurance premium rate as reduced from a normal insurance premium rate, and to calculate the sum of the insurance premium indicated by the received insurance premium information and the trading price, to thereby present the calculated insurance premium and the calculated sum to both of the involved parties.

According to such a constitution, the insurance premium is determined based on the discount insurance premium rate reduced from the normal insurance premium rate, in a case where both of the involved parties are to subscribe to the insurance. Thus, there can be reduced monetary burdens of involved parties due to the subscription to the insurance, as compared with a case where only one of the involved parties is to subscribe to the insurance, to thereby allow the involved parties to easily subscribe to the insurance during the transactional negotiation. Further, since both of the involved parties are to subscribe to the insurance, the monetary burden can be evenly shared between the parties, to thereby mitigate the complaint or dissatisfaction in case of the payment of the insurance premium by only one of the involved parties.

Moreover, to recommend the subscription to insurance during transactions in the electronic commerce, the insurance-task processing technique according to the present invention is characterized in that when a solicitation-related keyword as a clue of solicitation-to-insurance is included in transactional information related to the electronic commerce when sending the transactional information, the involved party receives the solicitation-to-insurance information transmitted from a server of an insurer.

According to such a constitution, the involved party receives the solicitation-to-insurance information transmitted from the server of the insurer, when the solicitation-related keyword as a clue of solicitation-to-insurance is included in the transactional information related to the electronic commerce when sending the transactional information. This allows the involved party to reconfirm the risk when conducting a transaction in the electronic commerce. Further, with a simple operation, a subscription applying screen for an insurance item is displayed, by burying a piece of link information to the subscription applying screen in the solicitation-to-insurance information. Thus, the involved party is possible to subscribe to the due insurance with a simple operation during the transaction in the electronic commerce, so that the involved party is protected.

At this time, if the risk related to the electronic commerce is notified before the transactional information is transmitted when the transactional keyword is included in the transactional information, the involved party is possible to previously reconfirm the risk in the electronic commerce. Thus, the involved party can be protected in a more reliable manner.

Meanwhile, to enable to objectively prove the occurrence of an accident, the insurance-task processing technique according to the present invention is characterized in that electronic information distributed within a computer network is monitored and the transactional information related to the electronic commerce is encrypted making use of a secret key to be preserved, when a completion keyword indicative of the completion of the transactional negotiation in the electronic commerce is included in the electronic information distributed in the computer network.

According to such a constitution, the transactional information is encrypted by the secret key and then preserved, when the completion keyword indicative of the completion of the transactional negotiation in the electronic commerce is included in the electronic information distributed in the computer network. Thus, the encrypted transactional information is utilized as the proof for proving the accident, to thereby protect the involved party. Note, the encrypted transactional information is decrypted by an insurer having the responsibility for paying the insured amount of money.

At this time, the secret key is generated based on the date and the time at the moment when the completion keyword is judged to be included in the transactional information, so that transaction details of respective transactions can be encrypted by individual secret keys, even if a large number of transactions are conducted in a short period of time. This makes it more difficult to falsify the transaction details as the proof. Further, the secret key is generated by the insurer having provided the insurance to which the involved party has subscribed. This keeps other involved parties from easily seeing the transaction details, to thereby avoid the leakage of private information. Moreover, since the secret key is provided from the insurer in the encrypted state, the involved party can be protected even when the secret key has fallen into a third party in bad faith.

Other objects and aspects of the present invention will become more apparent from the following description of preferred embodiments when read in conjunction with the accompanying drawings.

### BRIEF EXPLANATION OF THE DRAWINGS

FIG. 1 is a basic constitutional diagram of an insurance task processing system according to the present invention;

FIG. 2 shows operational models of the insurance task processing system, in which A is a constitutional diagram where a WWW server is managed by a service dealer, and B is a constitutional diagram where a WWW server is managed by a seller;

FIG. 3 is an explanatory view of basic constitutions and basic operations of a client and a WWW server;

FIG. 4 is an explanatory view of a word table;

FIG. 5 is an explanatory view of the principle for displaying solicitation-to-insurance information on a transaction-aimed screen;

FIG. 6 is an explanatory view of a basic operation of the insurance task processing system;

FIG. 7 is an explanatory view of the principle for selecting an insurer suitable for transactional information;

FIG. 8 is an explanatory view of the principle for displaying a warning message before sending transactional information;

FIG. 9 is an explanatory view of the principle for sending an electronic mail attached with the solicitation-to-insurance information to involved parties who have not yet subscribed to insurance;

FIG. 10 is an explanatory view of a transactional history database;

FIG. 11 is an explanatory view of a subscriber database;

FIG. 12 is a flowchart showing a process for judging whether or not involved parties have subscribed to due insurances corresponding to transaction details;

FIG. 13 is an explanatory view of the principle for providing solicitation-to-insurance information to involved parties who have not yet subscribed to insurance, at the request of a transaction-involved party;

FIG. 14 is an explanatory view of the principle for providing solicitation-to-insurance information to involved parties who have not yet subscribed to insurance in accordance with a keyword detection signal;

FIG. 15 is an explanatory view of the principle for displaying insurance premiums corresponding to the amount of transactional money;

FIG. 16 is an explanatory view of the principle for preserving, in a client, proof data for proving an accident; and

FIG. 17 is an explanatory view of the principle for preserving, in a WWW server, proof data for proving an accident.

Preferred Embodiments

There will be described hereinafter the present invention, with reference to the accompanying drawings.

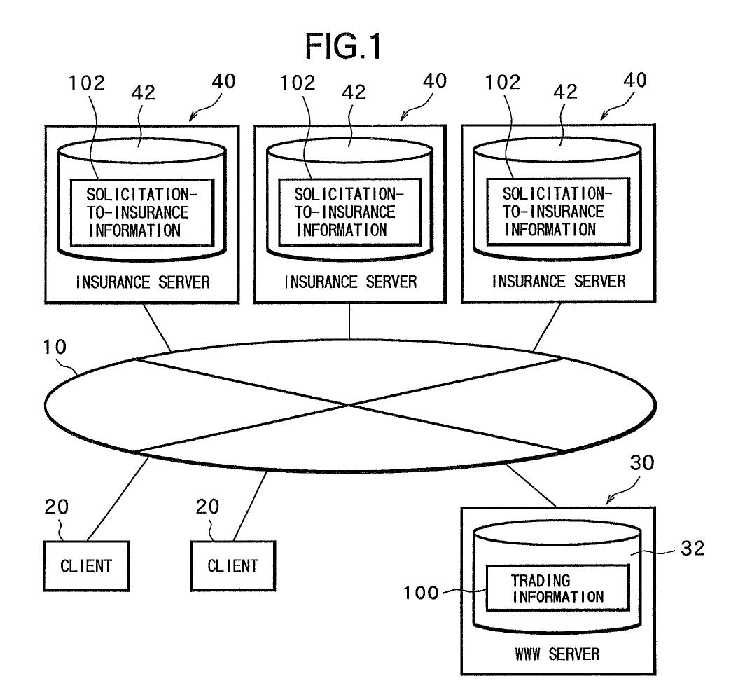

FIG. 1 shows a basic constitution of an insurance task processing system for embodying the insurance-task processing technique according to the present invention.

The insurance task processing system is constituted to include clients 20 interconnected with one another via Internet 10 constituting a computer network, a WWW (World Wide Web) server 30 and insurance servers 40 managed by insurers. The clients 20, WWW server 30 and insurance servers 40 are communicated with one another, such as via HTTP (Hypertext Transfer Protocol) widely used in the Internet. The WWW server 30 includes a database 32 registered with trading information 100 of such as commercial products being subjects of electronic commerce, and each insurance server 40 includes a database 42 registered with solicitation-to-insurance information 102 to be distributed to transaction-involved parties.

Each of the clients 20, WWW server 30 and insurance servers 40 is constituted of a computer at least provided with a memory and a central processing unit (CPU). Further, there are performed various tasks in the insurance task processing system, by programs loaded into memories, respectively.

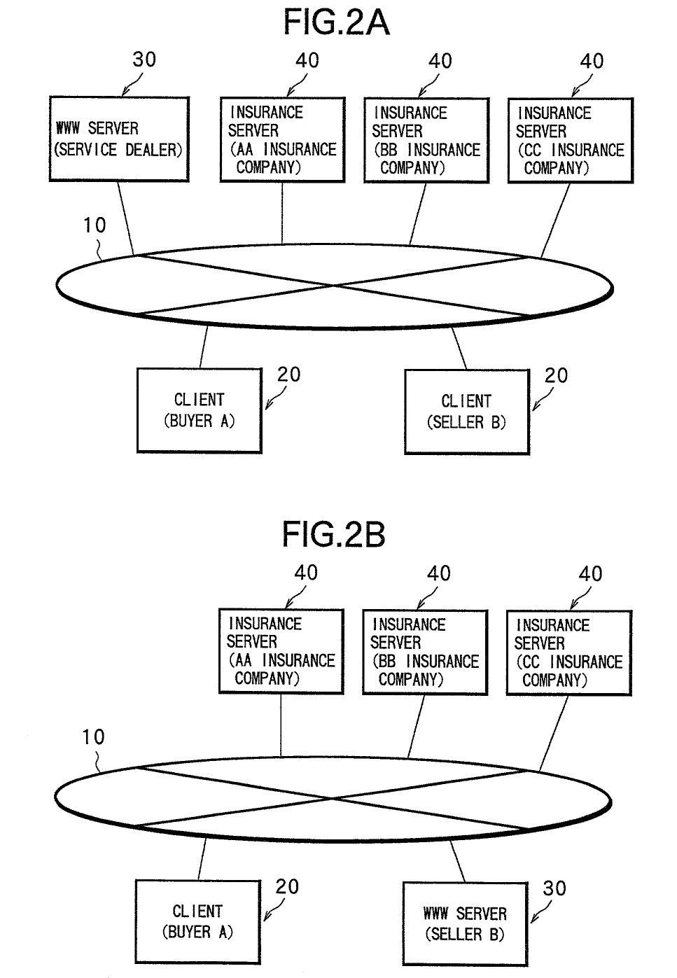

The insurance task processing system is managed in the following two models, corresponding to the presence/absence of a network service dealer (hereinafter merely called “service dealer”) for intermediating in transactions in the electronic commerce. Namely, in the presence of a service dealer, the WWW server 30 is managed by the service dealer as shown in FIG. 2A. In this case, the clients 20 are utilized by a buyer A and a seller B being transaction-involved parties, respectively. Contrary, in the absence of service dealers, the WWW server 30 is managed by a seller B being a transaction-involved party as shown in FIG. 2B. In this case, the client 20 is utilized by a buyer A. Conversely, it is possible that the WWW server 30 and client 20 are managed by the buyer A and seller B, respectively. In the shown operational models, insurance servers 40 are managed by AA insurance company, BB insurance company and CC insurance company, respectively.

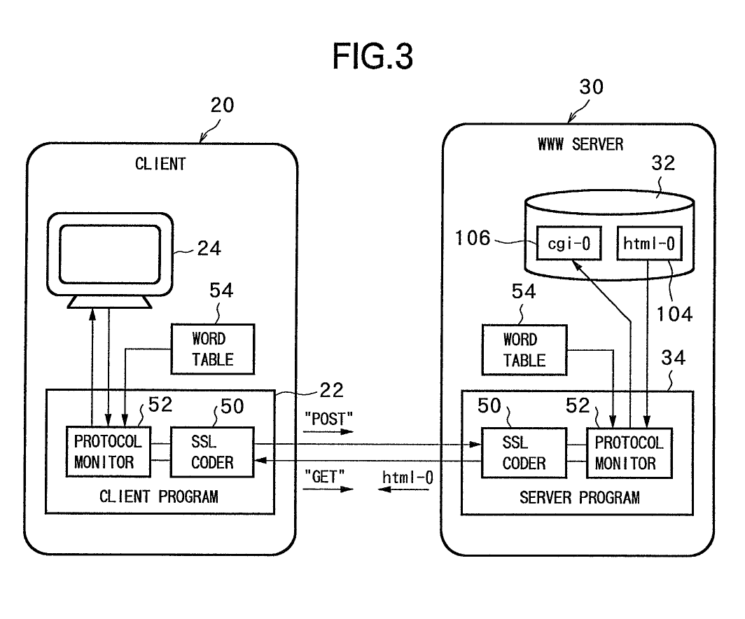

As shown in FIG. 3, the client 20 and WWW server 30 are installed with a client program 22 and a server program 34, respectively, each of which is provided with an SSL (Secure Socket Layer) coder 50 and a protocol monitor 52. In the SSL coder 50, encryption and decryption of transactional information are conducted, so as to conduct secret communication between the client 20 and WWW server 30. In the protocol monitor 52, it is monitored whether or not the transactional information transferred between the client 20 and WWW server 30 includes solicitation-related keywords registered in a word table 54. If it is detected that a solicitation-related keyword is included in the transactional information, a signal indicative of such inclusion (hereinafter called “keyword detection signal”) is output. Note, it is enough that the protocol monitor 52 is provided in at least one of the client 20 and WWW server 30.

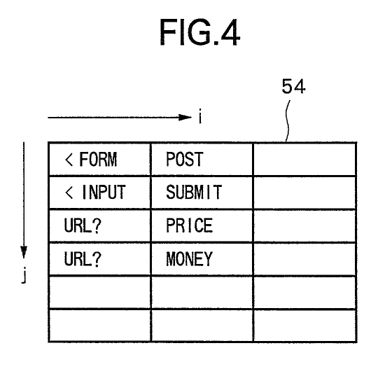

As shown in FIG. 4, the word table 54 has a two-dimensional table format. Each row (j-axis) of the word table 54 is registered with keywords in the column (i-axis) direction, for providing clues of solicitation-to-insurance. For example, the first row (j=1) is registered with a solicitation-related keyword “<FORM POST” as a clue of solicitation-to-insurance.

There will be now described the flow of transactional information transferred between the client 20 and WWW server 30, with reference to FIG. 3. Note, the explanation will be omitted for the encryption and decryption of the transactional information to be conducted by the SSL coder 50, in the following description.

When the HTML (HyperText Markup Language) data as trading information located on the WWW server 30 is to be referred in the client 20, a “GET” request including a URL (Uniform Resource Locator) indicative of the location of an HTML datum (html-0) 104 is sent to the WWW server 30. In the WWW server 30 having received the “GET” request, the database 32 is looked up so that the HTML datum 104 specified by the URL is sent to the client 20. Upon receiving the HTML datum 104, the client 20 displays it on a display device 24. Thereby the trading information can be viewed.

Then, when a “Send” button is pushed in the client 20 such as after inputting purchase desire details for the displayed trading information, a “POST” request including the purchase desire details is sent to the WWW server 30. At this time, it is possible to request, via a cgi (Common Gateway Interface) function, the transmitted purchase desire details to be processed by a particular (cgi-0) program 106.

There will be described hereinafter the principle for providing solicitation-to-insurance information during transactional negotiation in the electronic commerce, in the insurance task processing system. It is assumed here that the protocol monitor 52 is provided at the WWW server 30 side only, and the transactions in the electronic commerce are managed by the service dealer as shown in FIG. 2A. Such an assumption is also applicable to a case where the WWW server 30 is managed by the seller B as shown in FIG. 2B.

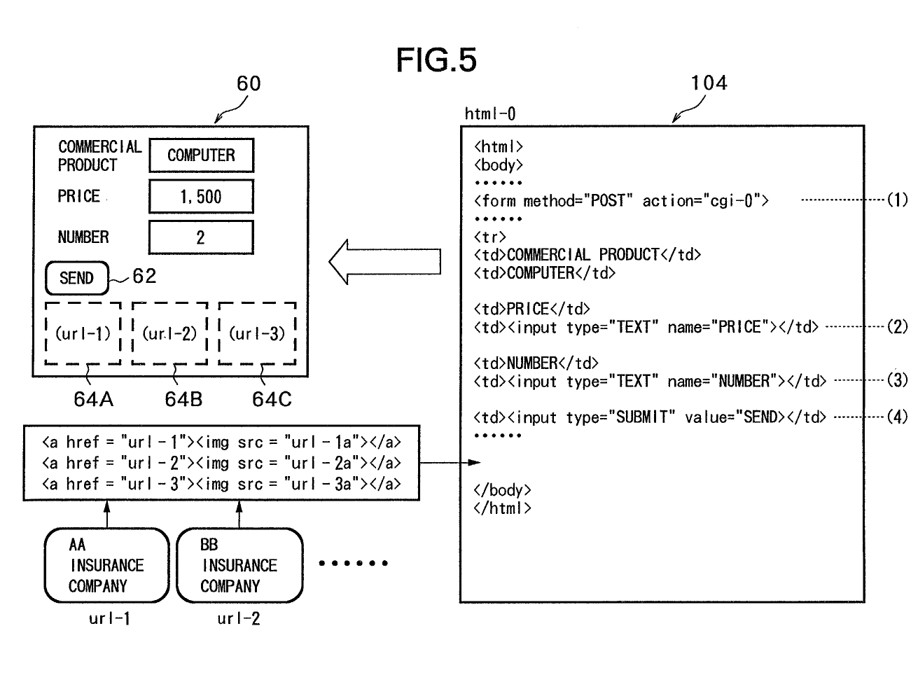

The seller B prepares the HTML (html-0) datum 104 such as shown in FIG. 5, as trading information of commercial products and the like to be sold through transactions in the electronic commerce. This HTML datum 104 has been described so as to display a transaction-aimed screen 60 at the upper left of FIG. 5. For example, defined in the HTML datum 104 are that (1) the transmitted data is to be processed by the particular program (cgi-0), (2, 3) prices and the number of commercial products can be input, and (4) the input data are to be sent by pressing down a button 62 named “Send”.

The example of FIG. 5 shows that those pieces of solicitation-to-insurance information from three insurers can be displayed on regions (url-1) 64A, (url-2) 64B and (url-3) 64C of the transaction-aimed screen 60, respectively. Just after displaying the transaction-aimed screen 60, no pieces of solicitation-to-insurance information are displayed. When the keyword detection signal is output from the protocol monitor 52, a definition line(s) is inserted into a predetermined position(s) of the HTML datum 104, for displaying solicitation-to-insurance information. For example, if the solicitation-to-insurance information of the AA insurance company is to be displayed, a definition line <a href=“url-1”><img src=“url-1a”></a>is inserted into a predetermined position of the HTML datum 104, and the solicitation-to-insurance information of the AA insurance company is displayed on the region (url-1) 64A.

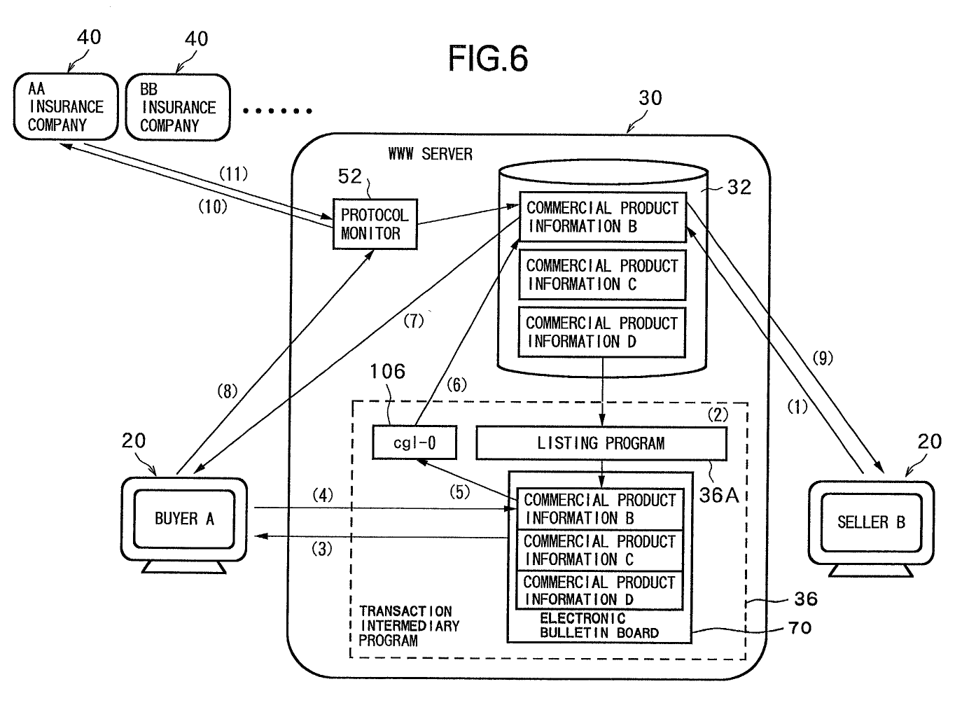

After preparing the HTML datum 104, the seller B registers commercial product information B into the database 32 of the WWW server 30 as shown in FIG. 6 (procedure (1)). The commercial product information B is constituted to include a name (such as a personal name or a company's name), a summary of the commercial product information (such as product name, price), the HTML datum 104, and a contact address (such as mail address). In the following description, it is supposed that the database 32 is already registered with commercial product information C and commercial product information D of a seller C and a seller D, respectively, in addition to the commercial product information B of the seller B.

A listing program 36A performing one of functions of a transaction intermediary program 36 of the WWW server 30 is activated. Then, the listing program 36A extracts only summaries from the commercial product information B to D registered in the database 32, and automatically edits these summaries into formats to be bulletined on an electronic bulletin board 70 (procedure (2)). Then, the automatically edited summaries of the commercial product information are listed on the electronic bulletin board 70.

The buyer A utilizes a “GET” request to thereby access to the electronic bulletin board 70 of the WWW server 30 (procedure (3)), and then designates the commercial product information B in the list. Then a “POST” request is sent from the client 20 of the buyer A to the WWW server 30, so as to request the HTML datum 104 for the commercial product information B (procedure (4)). In the WWW server 30 having received the “POST” request, the designated (cgi-0) program 106 is activated so as to process the “POST” request (procedure (5)). The program 106 retrieves the HTML datum 104 from the commercial product information B registered in the database 32 (procedure (6)), and sends the HTML datum 104 to the client 20 of the buyer A (procedure (7)). Thereby the transaction-aimed screen 60 shown in FIG. 5 is displayed on the client 20 of the buyer A. Thereafter, the trading negotiation between the buyer A and seller B is conducted, such as via electronic mails, or by sharing the transaction-aimed screen 60 shown in FIG. 5. Note, it is further assumed here that the trading negotiation is to be conducted via transaction-aimed screen 60.

When the buyer A pushes down the “Send” button 62 after inputting the transactional information such as the prices and the number of products, the transactional information is sent to the WWW server 30 (procedure (8)). In the WWW server 30 having received the transactional information, the transactional information is sent to the client 20 of the seller B via the protocol monitor 52 (procedure (9)).

At this time, the word table 54 is looked up by the protocol monitor 52, to monitor whether the transactional information includes a solicitation-related keyword as a clue of solicitation-to-insurance. When such an solicitation-related keyword as a clue of solicitation-to-insurance is found, an insurer who is to provide the solicitation-to-insurance information is selected in accordance with the processing to be described later, and a keyword detection signal is sent to the insurance server 40 of the selected insurer (procedure (10)). The insurance server 40 having received the keyword detection signal sends the solicitation-to-insurance information registered in a database 42 thereof to the WWW server 30 (procedure (11)). In the WWW server 30 having received the solicitation-to-insurance information, the definition lines for displaying the solicitation-to-insurance information are inserted into predetermined positions of the HTML datum 104 constituting the transaction-aimed screen 60. This causes the transaction-aimed screen 60 to display the solicitation-to-insurance information.

Note, an input step, an input function, input means, a sending step, a sending function and sending means are realized by the processing in the procedure (8). Further, an solicitation-judging step, a solicitation-judging function and solicitation-judging means are realized by the series of processing in the procedure (10). Moreover, a distributing step, a distributing function and distributing means are realized by the processing conducted in the procedure (11) and the processing for inserting the definition lines for displaying the solicitation-to-insurance information into the HTML datum 104. In addition, a receiving step, a receiving function and receiving means are realized by the processing for displaying the solicitation-to-insurance information on the transaction-aimed screen 60.

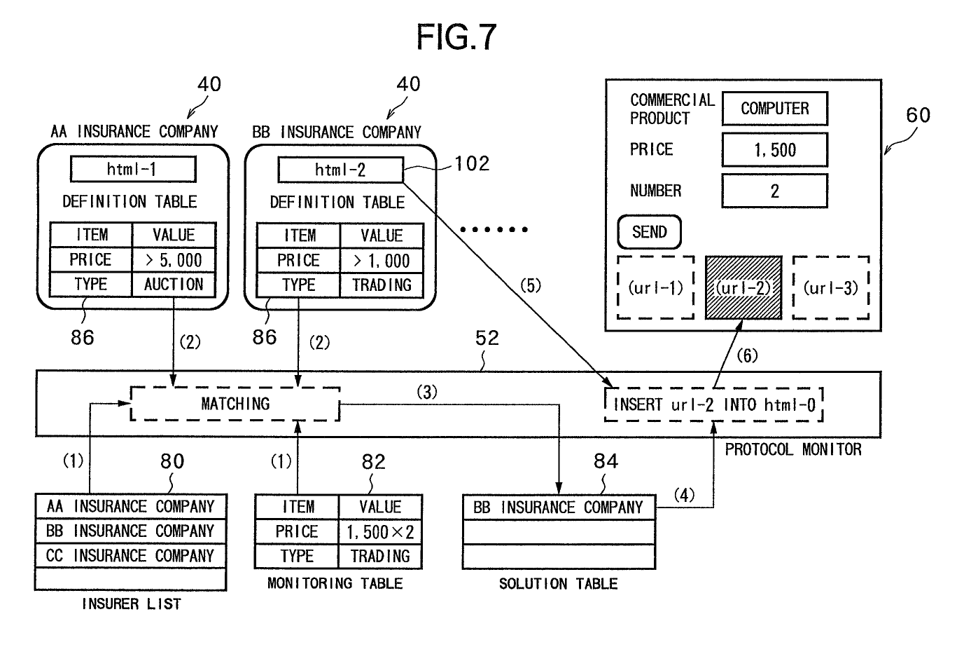

FIG. 7 shows processing to be conducted in the protocol monitor 52 so as to select an insurer.

The WWW server 30 is provided with an insurer list 80 registered with names of insurers who distribute pieces of solicitation-to-insurance information, a monitoring table 82 which has collected the newest transactional information between the transaction-involved parties, and a solution table 84 registered with the name of insurer selected in accordance with the transactional information. Here, the monitoring table 82 is updated at any time by the protocol monitor 52 which monitors the transactional information to be transferred between the client 20 and the WWW server 30.

Meanwhile, the insurance server 40 of the insurer is provided with a definition table 86 for defining conditions for providing solicitation-to-insurance information (hereinafter called “providing conditions”). The definition table 86 of the AA insurance company defines, as the providing conditions, that the trading price is higher than ¥5,000, and that the transaction type is “auction”. The definition table 86 of the BB insurance company defines, as the providing conditions, that the trading price is higher than ¥1,000, and that the transaction type is “trading transaction”.

It is now assumed that there will be conducted the trading transaction in which the trading price is ¥1,500 and the number of products is 2, as registered in the monitoring table 82. In the protocol monitor 52, the insurer list 80 and the monitoring table 82 are read out (procedure (1)), so as to refer to the definition table 86 of each of the insurers registered in the insurer list 80 (procedure (2)). Then, it is judged which of the insurers provides an insurance item suitable for the transactional information. In the shown example, since the trading transaction is the trading price of ¥3,000 (=¥1,500×2), it is judged that the insurance item provided by the BB insurance company is suitable, and the BB insurance company as the judgment result is registered into the solution table 84 (procedure (3)). Next, the solution table 84 is read out (procedure (4)), and a URL indicative of the location of the solicitation-to-insurance information (html-2) 102 of the BB insurance company is inserted into a predetermined position of the HTML datum (html-0) 104 defining the transaction-aimed screen 60 (procedure (5)). As a result, the transaction-aimed screen 60 of the transaction-involved party is displayed with the solicitation-to-insurance information of the BB insurance company as shown (procedure (6)).

Thus, the transaction-involved party is possible to reconfirm the risk when conducting a transaction in the electronic commerce, since the transaction-aimed screen 60 displays the solicitation-to-insurance information corresponding to the transaction details. Further, if link information to a subscription applying screen for an insurance item provided by the insurer is buried in the solicitation-to-insurance information, it is also possible to display the subscription applying screen for the insurance item such as by clicking the link information. This enables the transaction-involved party to subscribe to insurance with a simple operation during a transaction in the electronic commerce, to thereby enabling to protect transaction-involved parties.

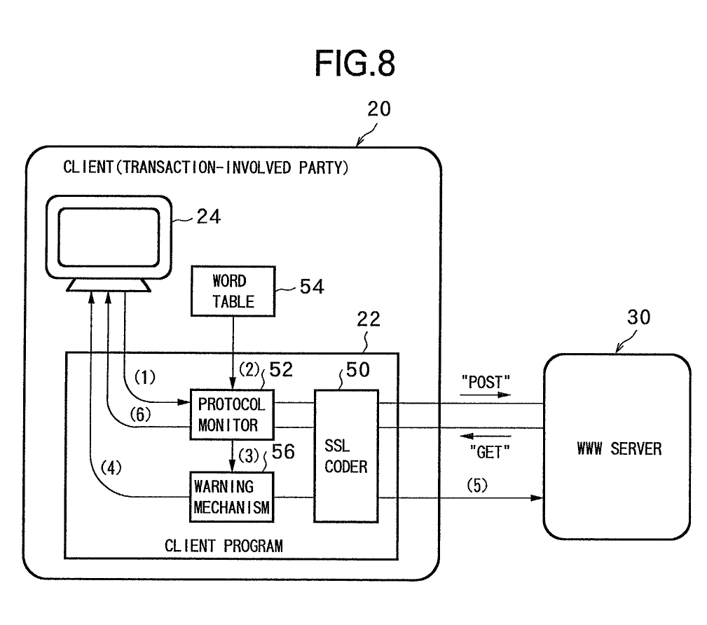

FIG. 8 shows the principle for notifying the risk in the electronic commerce to a transaction-involved party and for providing solicitation-to-insurance information, before the transactional information is actually sent.

The client 20 of the transaction-involved party is provided with a warning mechanism 56, in addition to the aforementioned SSL coder 50, protocol monitor 52 and word table 54. The warning mechanism 56 mainly performs a function to display a warning message on the display device 24, based on the keyword detection signal as a clue from the protocol monitor 52.

When the “Send” button 62 is pushed down in the transaction-aimed screen 60 after inputting the prices and the number of products, the transactional information is transmitted to the protocol monitor 52 (procedure (1)). In the protocol monitor 52, the transmitted transactional information is monitored, so as to judge whether the transactional information includes an important word (such as “POST”, “PRICE”) as a transactional keyword registered in the word table 54 (procedure (2)). If it is found that an important word is included in the transactional information, the warning mechanism 56 is activated (procedure (3)), and the warning message is displayed on the display device 24 (procedure (4)). Simultaneously therewith, the warning mechanism 56 notifies the WWW server 30 of the chance of solicitation-to-insurance (procedure (5)), and then the solicitation-to-insurance information distributed by the insurer is displayed on the display device 24 through the aforementioned procedures (procedure (6)). According to the procedures up to then, the transactional information itself has not been yet sent to the WWW server 30, although the “Send” button 62 has been once pushed down on the transaction-aimed screen 60. Namely, the transactional information is sent to the WWW server 30, only when the “Send” button 62 is pushed down again.

The series of procedures in the procedure (2) realizes a transaction judging step. Further, the procedure in the procedure (3) realizes a risk notifying step.

Thus, the first pushing down of the “Send” button 62 is merely utilized as a trigger for displaying the warning message and the solicitation-to-insurance information, therefore it is possible to reconfirm the risk of a transaction in the electronic commerce before the transactional information is actually transmitted. Differently from the aforementioned embodiment, in this case, since the warning message and the solicitation-to-insurance information are displayed if the important word is included in the transactional information, the transaction-involved parties are protected in a more reliable manner.

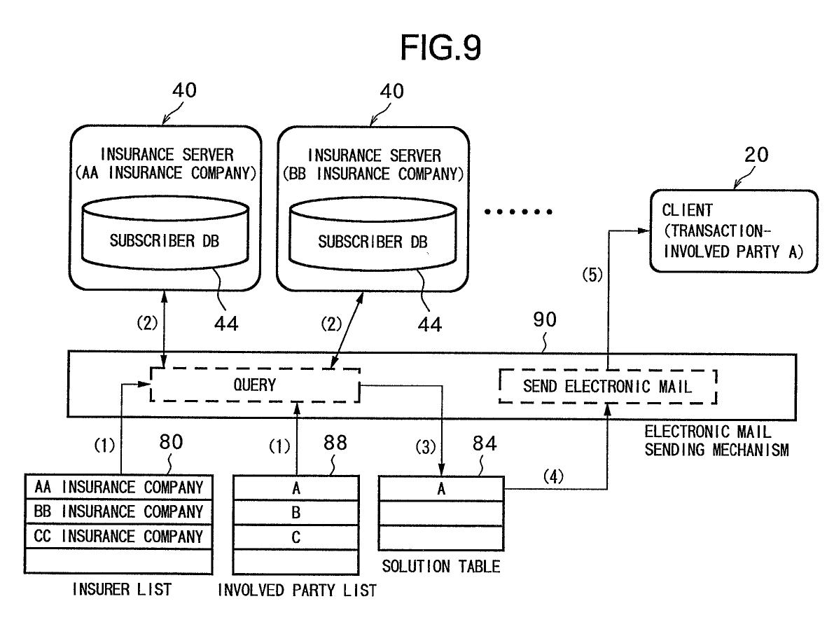

FIG. 9 shows the principle for sending an electronic mail attached with the solicitation-to-insurance information to a transaction-involved party who has not yet subscribed to insurance. By the series of procedures to be described hereinafter, a distributing step, a distributing function and distributing means are realized.

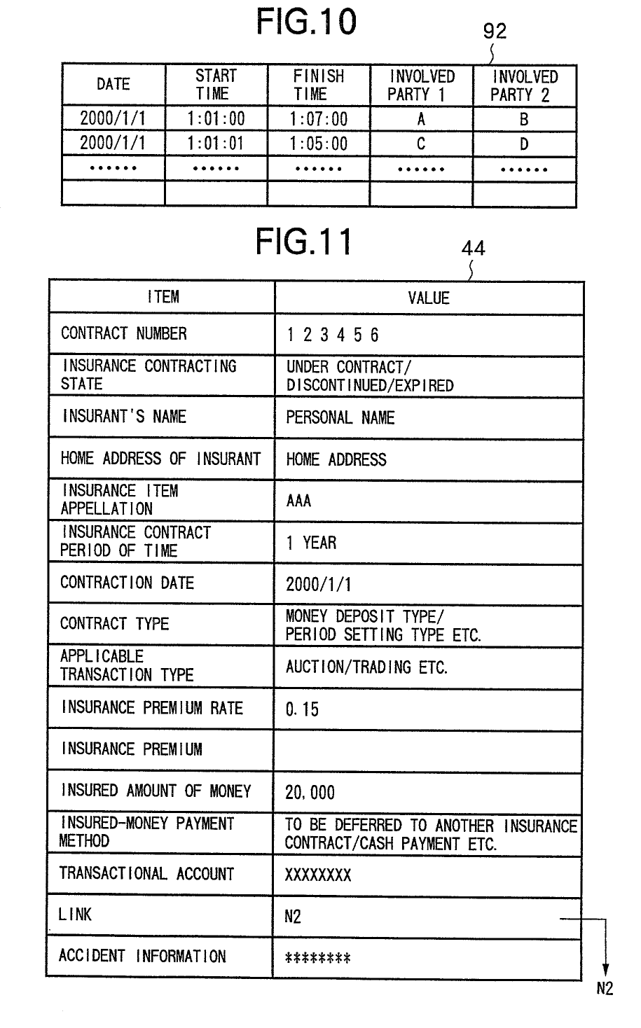

The WWW server 30 is provided with an insurer list 80, an involved party list 88 registered with names of transaction-involved parties, a solution table 84 registered with names of transaction-involved parties as destinations to be provided with the solicitation-to-insurance information, and an electronic mail sending mechanism 90. The involved party list 88 is created based on a transactional history database 92 (see FIG. 10) registered with the transactional history between respective transaction-involved parties, i.e., registered with at least the date, the start time, the finish time and respective parties involved in each transaction. Note, the transactional history database 92 is updated at any time by the protocol monitor 52 which monitors the transactional information to be transferred between the client 20 and WWW server 30.

Meanwhile, each insurance server 40 of an insurer is provided with a subscriber database 44. As shown in FIG. 11, the subscriber database 44 is registered with a contract number, an insurance contracting state, an insurant's name, an insurant's home address, an insurance item appellation, an insurance contract period of time, a contraction date, a contract type, an applicable transaction type, an insurance premium rate, an insurance premium, an insurance benefit payment method, a transactional account, a link (to another insurance contract of the same person), and accident information.

In the electronic mail sending mechanism 90, the insurer list 80 and involved party list 88 are read out (procedure (1)), and the subscriber databases 44 of the respective involved parties registered in the insurer list 80 looked up to thereby retrieve insurance contracting states of the transaction-involved parties registered in the involved party list 88, respectively (procedure (2)). When it is judged, according to the procedures to be described later, that a transaction-involved party has not yet subscribed to insurance corresponding to transaction details, the transaction-involved party's name is registered into the solution table 84 (procedure (3)). Next, the solution table 84 is read out (procedure (4)), and an electronic mail attached with the solicitation-to-insurance information of the insurer determined by the aforementioned procedures is sent to each of the transaction-involved parties registered in the solution table 84 (procedure (5)).

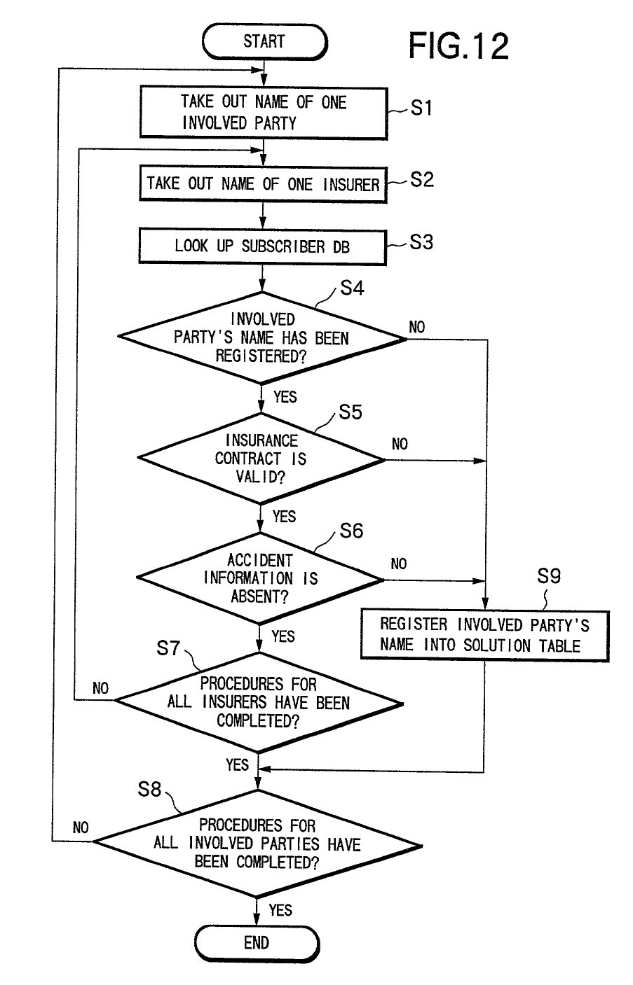

FIG. 12 shows a process for judging whether or not the involved party has subscribed to the insurance corresponding to transaction details.

At step 1 (abbreviated to “S1” in the figure; and the same rule applies corresponding to the following), one of transaction-involved parties' names is taken out from the involved party list 88. Namely, when this step 1 is executed for the first time the transaction-involved party's name registered at the first row of the involved party list 88 is taken out. Thereafter, a transaction-involved party's name registered at the next row, i.e., the second row, third row . . . of the involved party list 88 is sequentially taken out, each time when step 1 is executed.

At step 2, one of insurers' names is taken out from the insurer list 80. Namely, in conducting the looped procedures from step 2 through step 7, when step 2 is executed for the first time, the insurer's name registered at the first row of the insurer list 80 is taken out. Thereafter, an insurer's name registered at the next row, i.e., the second row, third row . . . of the insurer list 80 is sequentially taken out, each time when step 2 is executed.

At step 3, the subscriber database 44 of the insurer to be specified by the insurer's name is looked up, based on the transaction-involved party's name as a key.

At step 4, it is judged whether or not the transaction-involved party's name has been registered in the subscriber database 44. Namely, it is judged whether or not the involved party has once subscribed to any insurance item provided by the insurer. If the transaction-involved party's name has been registered in the subscriber database 44(Yes), the flow advances to step 5, while if the transaction-involved party's name has not been registered in the subscriber database 44(No), the flow advances to step 9.

At step 5, it is judged, based on the insurance contracting state registered in the subscriber database 44 (see FIG. 11), whether or not the insurance contract of the transaction-involved party is still valid at present. If the insurance contract is still valid (Yes), the flow advances to step 6, while if the insurance contract is not valid, i.e., if the insurance contract is discontinued or has expired (No), the flow advances to step 9.

At step 6, it is judged, based on the accident information of the subscriber database 44 (see FIG. 11), whether or not the accident information has been registered, i.e., whether or not the involved party has encountered an accident. If no accident information has been registered (Yes), the flow advances to step 7, while if the accident information has been registered (No), the flow advances to step 9.

At step 7, it is judged whether or not the procedures have been completed for all the insurer names registered in the insurer list 80. If the procedures have been completed (Yes), the flow advances to step 8, while if the procedures have not been completed (No), the flow returns to step 2.

At step 8, it is judged whether or not the procedures have been completed for all the involved parties registered in the involved party list 88. If the procedures have been completed (Yes), the insurance un-subscription judging process is terminated, while if the procedures have not been completed (No), the flow returns to step 1.

At step 9, the transaction-involved party's name is registered into the solution table 84, and then the flow advances to step 8. At this time, when the transaction-involved party's name has been already registered in the solution table 84, it is preferable to skip step 9 so as to avoid overlapped registration.

According to the procedures of steps 1 through 9 as described above, the involved party's name is registered into the solution table 84, (1) when the transaction-involved party's name is not registered in anyone of the subscriber databases 44, (2) when the insurance contract of the transaction-involved party is invalid, or (3) when the transaction-involved party has encountered an accident. Namely, when the transaction-involved party has not yet subscribed to insurance corresponding to the transaction details, the transaction-involved party's name is registered into the solution table 84 so as to distribute the solicitation-to-insurance information to the transaction-involved party.

Thus, the solicitation-to-insurance information is not distributed to the transaction-involved parties who have already subscribed to the insurance corresponding to the transaction details. This avoids such a situation that transaction-involved parties feel annoyed at unnecessary solicitation-to-insurance information. Meanwhile, since the solicitation-to-insurance information are preferentially distributed to the transaction-involved parties who have once encountered accidents and thus are aware of the necessity of subscribing to the insurance, such involved parties are possible to be reminded of the risk of transactions in the electronic commerce.

In this embodiment, it is possible to replace the involved party list 88 with the monitoring table 82 at least registered with the names of both of the transaction-involved parties. In this case, the monitoring table 82 is updated whenever the transaction in the electronic commerce is started or terminated, by the protocol monitor 52 which monitors the transactional information transferred between the client 20 and WWW server 30.

In this embodiment, the solicitation-to-insurance information has been distributed corresponding to the keyword detection signal from the protocol monitor 52. However, it is also possible to distribute, at the request from one of the transaction-involved parties, the solicitation-to-insurance information to the other.

It is further possible to distribute the solicitation-to-insurance information to a transaction-involved party who has not yet subscribed to insurance, after the transactional negotiation itself in the electronic commerce has been completed, i.e., when the transactional negotiation itself has been completed but the actual transaction itself has not been conducted yet. This allows the transaction-involved party to subscribe to the insurance even after the completion of the transactional negotiation, to thereby protect the transaction-involved party in a more reliable manner.

In addition, the electronic mail sending mechanism 90 may be provided in the insurance server 40 of the insurer.

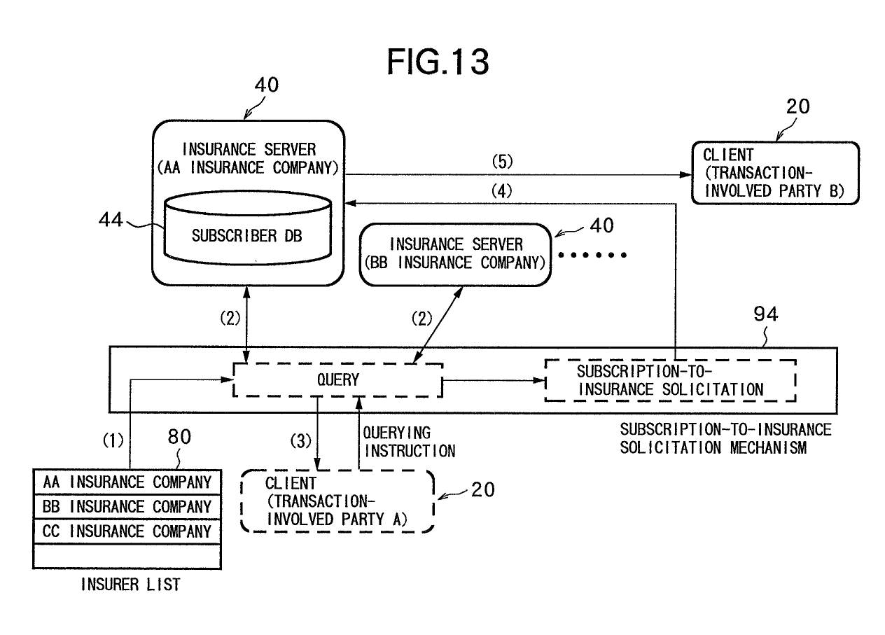

FIG. 13 shows the principle for providing, at the request of one of the transaction-involved parties, the solicitation-to-insurance information to the transaction-involved party who has not yet subscribed to insurance. It is assumed here that the client 20 or WWW server 30 is provided with a subscription-to-insurance solicitation mechanism 94, and the insurance server 40 is provided with the subscriber database 44. A distributing step, a distributing function and distributing means are realized by the series of procedures to be described hereinafter.

The insurer list 80 provided in the WWW server 30 is input, when the subscription-to-insurance solicitation mechanism 94 has received, from the client 20 of a transaction-involved party A, a query instruction concerning an insurance subscription state of a transaction-involved party B as a transactional fellow (procedure (1)). Then, the insurance subscription state of the transaction-involved party B is queried to each of the insurance servers 40 of the respective insurers (procedure (2)), similarly to the embodiment of FIG. 9. The insurance subscription state of the transaction-involved party B is displayed on the client 20 of the transaction-involved party A (procedure (3)). If the transaction-involved party B has not yet subscribed to insurance, the insurance server 40 of the insurer to which the transaction-involved party A has subscribed, is requested to send the solicitation-to-insurance information to the transaction-involved party B (procedure (4)). The insurance server 40, which has received the sending request of the solicitation-to-insurance information, sends such solicitation-to-insurance information to the client 20 of the transaction-involved party B (procedure (5)).

Thus, during the transactional negotiation, the transaction-involved party A is possible to confirm the insurance subscription state of the transaction-involved party B as the transactional fellow, so as to estimate the reliability of the transactional fellow. When the transaction-involved party B has not yet subscribed to insurance, the solicitation-to-insurance information is sent to the transaction-involved party B. As a result, the transaction-involved party A is possible to take a due countermeasure so as to previously avoid an occurrence of loss, in view of the behavior of the transaction-involved party B to whom the solicitation-to-insurance information has been sent. For example, if the transaction-involved party B has refused the subscription to insurance, the transaction-involved party A can cease the transactional negotiation with the transaction-involved party B.

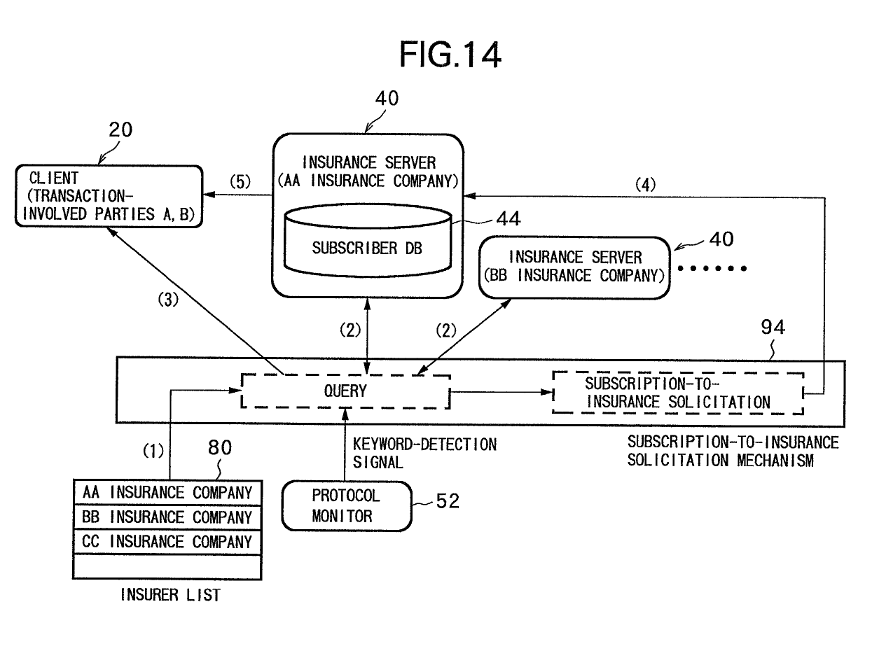

FIG. 14 shows the principle for providing the solicitation-to-insurance information to a transaction-involved party who has not yet subscribed to insurance, corresponding to a keyword detection signal. It is assumed here that the WWW server 30 is managed by a service dealer, and the WWW server 30 is provided with the subscription-to-insurance solicitation mechanism 94. A distributing step, a distributing function and distributing means are realized by the series of procedures to be described hereinafter.

When the keyword detection signal is input from the protocol monitor 52 into the subscription-to-insurance solicitation mechanism 94, the insurer list 80 provided in the WWW server 30 is input (procedure (1)). Then, the insurance subscription states of the transaction-involved parties A and B are queried to the insurance servers 40 of the involved parties, respectively (procedure (2)), similarly to the embodiment of FIG. 9. Thereafter, the insurance subscription state of the transaction-involved party A is displayed on the client 20 of the transaction-involved party B, while the insurance subscription state of the transaction-involved party B is displayed on the client 20 of the transaction-involved party A (procedure (3)). If the transaction-involved party A and/or B has not yet subscribed to insurance, the insurance server 40 of the insurer recommended by the service dealer is requested to send the solicitation-to-insurance information to the transaction-involved party who has not yet subscribed to insurance (procedure (4)). The insurance server 40 having received the request to send the solicitation-to-insurance information, sends the solicitation-to-insurance information to the client 20 of the transaction-involved party who has not yet subscribed to insurance (procedure (5)).

Thus, each one of the transaction-involved parties is possible to confirm the insurance subscription state of the other transaction-involved party as a transactional fellow, so as to estimate the reliability of the transactional fellow. Further, it becomes possible to reconfirm the necessity of the subscription to insurance during the transactional negotiation, and to protect the transaction-involved parties by mutually subscribing to the due insurances.

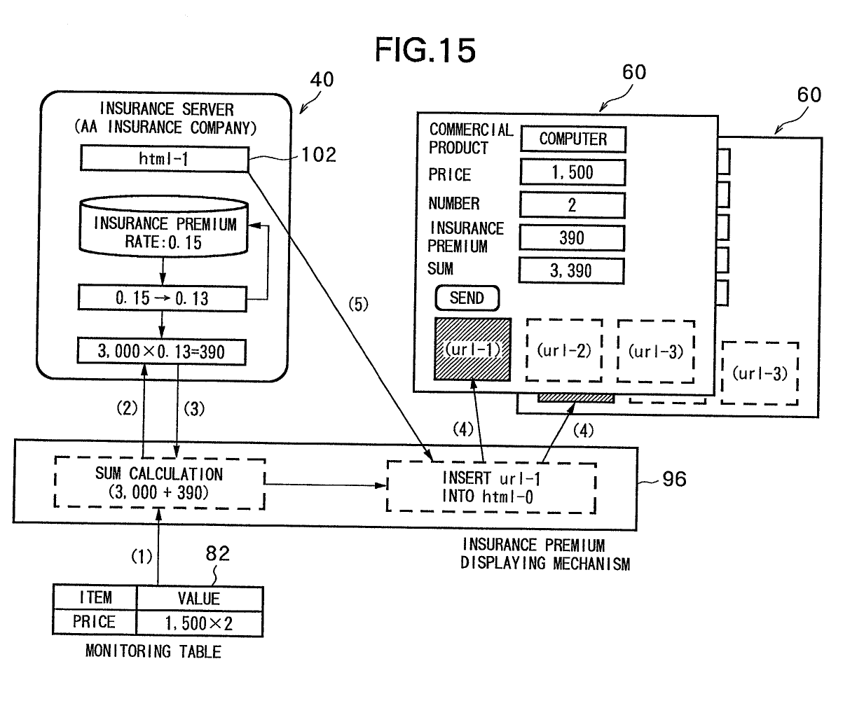

FIG. 15 shows the principle for additionally displaying the insurance premiums corresponding to the transaction value, to both of the transaction-involved parties, when displaying the solicitation-to-insurance information on the transaction-aimed screens 60, respectively. It is assumed here that the WWW server 30 is managed by a service dealer and the WWW server 30 is provided with an insurance premium displaying mechanism 96.

When the keyword detection signal is input from the protocol monitor 52 into the insurance premium displaying mechanism 96, the monitoring table 82 to be updated by the protocol monitor 52 at any time (procedure (1)) is input. The insurance premium displaying mechanism 96 selects an insurer corresponding to the transaction details, based on the aforementioned procedures, and sends an insurance premium calculating request to the insurance server 40 of the insurer (procedure (2)). In the insurance server 40 having received the insurance premium calculating request, an insurance premium corresponding to the amount of transactional money is calculated utilizing a discount insurance premium rate (0.13) as reduced from a normal insurance premium rate (0.15), and the calculated insurance premium information is sent to the insurance premium displaying mechanism 96 (procedure (3)). In the insurance premium displaying mechanism 96 having received the calculated insurance premium information, the total amount of money as the sum of the transactional money and insurance premium is calculated, and then the insurance premium and the total amount of money are displayed on each transaction-aimed screen 60 (procedure (4)). Further, In the insurance premium displaying mechanism 96, inserts: the solicitation-to-insurance information (html-1) 102 registered in the insurance server 40 is inserted into a predetermined position of an HTML datum (html-0) for defining the transaction-aimed screen 60, so that the solicitation-to-insurance information of the insurer is displayed on each transaction-aimed screen 60 (procedure (5)).

Note, an insurance premium information receiving step, a sum calculating step and a presenting step are realized by the processing of the procedure (4).

In this way, the insurance premium is determined based on the discount insurance premium rate reduced from a normal insurance premium rate, when both of the transaction-involved parties are to subscribe to the insurance. Thus, there can be reduced monetary burdens of involved parties due to the subscription to the insurance, as compared with a case where only one of the involved parties is to subscribe to the insurance. Therefore, the involved parties are possible to easily subscribe to the insurance during the transactional negotiation to thereby protect the transaction-involved parties by the subscription to the insurance. Further, since both of the involved parties are to subscribe to the insurance, the monetary burden can be evenly shared between the parties, to thereby mitigate the complaint or dissatisfaction in case of the payment of the insurance premium by only one of the involved parties.

There will be described hereinafter a constitution for objectively proving an accident caused in a transaction in the electronic commerce.

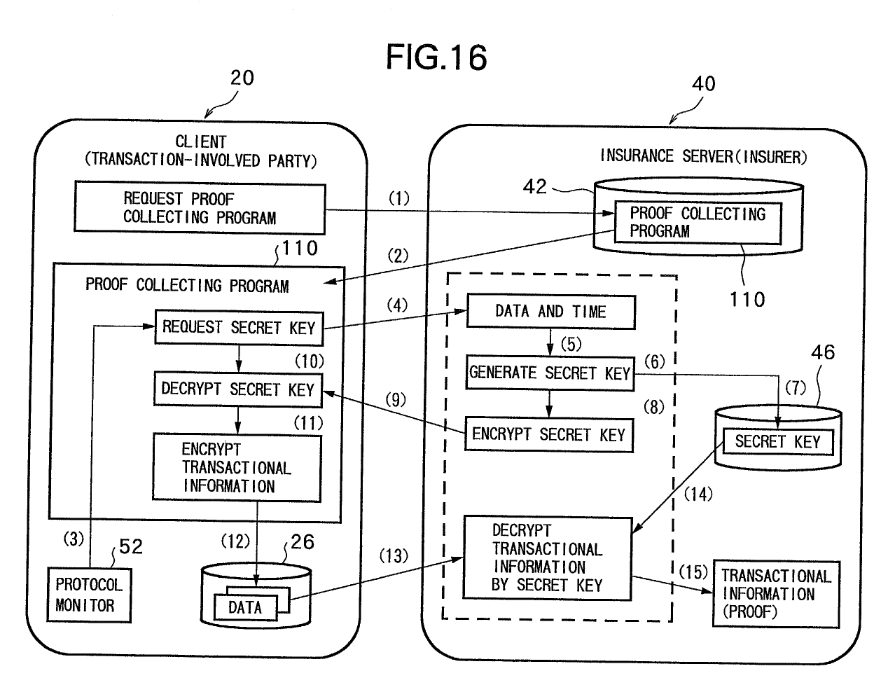

FIG. 16 shows a constitution for preserving proof data in the client 20. In this embodiment, the protocol monitor 52 is assumed to output a keyword detection signal, when a completion keyword indicative of the completion of a transactional negotiation is found in the transactional information to be transferred between the transaction-involved parties.

When the client 20 forwards to the insurance server 40 of an insurer, a request to send to the client 20 a proof collecting program 110 for recording proof data (procedure (1)), the proof collecting program 110 registered in the database 42 in the insurance server 40 is sent to the client 20 (procedure (2)). In the client 20 having received the proof collecting program 110, this proof collecting program 110 is installed in an executable state. It is preferable here that the proof collecting program 110 is transmitted in a compressed state.

When the proof collecting program 110 is input with a keyword detection signal from the protocol monitor 52 (procedure (3)), the transactional information at that moment is temporarily stored, and a secret key generating request is sent to the insurance server 40 (procedure (4)). In the insurance server 40 having received the secret key generating request, the date and the time at that moment are read out (procedure (5)), and a secret key is generated based on the date and the time (procedure (6)). In generating the secret key, there is utilized a known technique such as an RSA (Rivest Shamir Adleman) algorithm. The thus generated secret key is preserved in a database 46, in a manner related to the date and the time at the transaction-involved party (procedure (7)). Further, the generated secret key is encrypted by an encryption technique specific to the insurer (procedure (8)). The encrypted secret key is then sent to the client 20 of the transaction-involved party (procedure (9)).

In the client 20 having received the encrypted secret key, the secret key is decrypted by a decrypting technique specific to the insurer (procedure (10)). Further, the transactional information temporarily stored by the thus decrypted secret key is encrypted (procedure (11)). The thus encrypted transactional information is preserved in a file 26, in a state related to the date and the time (procedure (12)).

Note, a completion-judging step, a completion-judging function and completion-judging means are realized by the processing of the procedure (3). An encrypting step, an encrypting function and encrypting means are realized by the processing of the procedure (11). Further, a preserving step, a preserving function and preserving means are realized by the processing of the procedure (12).

In this way, when a completion keyword indicative of the completion of the transactional negotiation is found in the transactional information to be transferred between the transaction-involved parties, the transactional information is encrypted by the secret key generated based on the date and the time at that moment. Further, the encrypted transactional information is preserved into the file 26 of the client 20, in the state related to the date and the time at that moment. These consecutive procedures are automatically executed by the proof collecting program 110 distributed from the insurance server 40, so that the transaction-involved party is noway involved in collecting proof for proving an accident.

In case of the occurrence of accident in a transaction in the electronic commerce, if the transaction-involved party specifies the date and the time of the accident occurrence when applying for an insurance benefit payment, then the encrypted transactional information is retrieved from the file 26 and sent to the insurance server 40 together with an insurance benefit payment application (procedure (13)). In the insurance server 40 having received the encrypted transactional information, the corresponding secret key is taken out from the database 46 based on the date and the time specified in the insurance benefit payment application (procedure (14)), and the transactional information is decrypted by the thus taken out secret key (procedure (15)). Then, the decrypted transactional information is utilized as the proof data concerning the insurance benefit payment application.

Thus, the proof required to prove the accident can be collected in a manner unrecognized by the transaction-involved party, to thereby reduce the burden for presenting an objective proof of the occurrence of accident. Further, the transactional information as the collected proof is disclosed only upon occurrence of accident, thereby minimizing the leakage of private information. Even in such a situation of disclosure, since the transactional information has been encrypted by the secret key generated by the insurance server 40, it is difficult for the transaction-involved party to falsify the transactional information as the proof, so that the proof value of the transactional information can be increased. Thus, the occurrence of accident can be objectively proved, to thereby enable the protection of the transaction-involved party.

Note, the proof collecting program 110 may be constituted to be distributed to the client 20 from the WWW server 30 of a service dealer intermediating in transactions in the electronic commerce. In this case, it is required that the WWW server 30 is previously registered with the proof collecting program 110 distributed and committed from the insurer. Meanwhile, the proof collecting program 110 may be constituted to be again distributed from the client 20 of the transaction-involved party to the client 20 of the other transaction-involved party as a transactional fellow,.

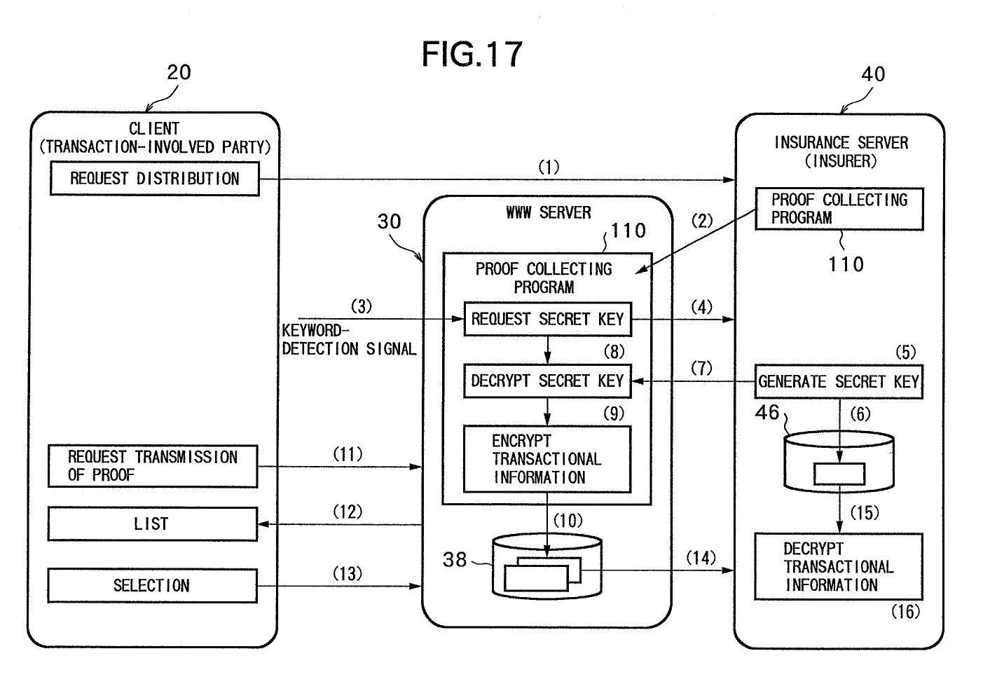

As shown in FIG. 17, it is possible that the transactional information as the proof for proving the accident in a transaction in the electronic commerce is preserved in the WWW server 30.

When the client 20 forwards to the insurance server 40 of an insurer, a request to send to the client 20 a proof collecting program 110 for recording proof data (procedure (1)), the proof collecting program 110 registered in the database 42 in the insurance server 40 is sent to the WWW server 30 (procedure (2)). In the WWW server 30 having received the proof collecting program 110, this proof collecting program 110 is installed in an executable state.

When the proof collecting program 110 is input with a keyword detection signal from the protocol monitor 52 (procedure (3)), the transactional information at that moment is temporarily stored, and a secret key generating request is sent to the insurance server 40 (procedure (4)). In the insurance server 40 having received the secret key generating request, a secret key is generated based on the aforementioned secret key generating method (procedure (5)). The thus generated secret key is preserved in the database 46, in a manner related to the date and the time at the transaction-involved party (procedure (6)). Further, the generated secret key is encrypted and then transmitted to the WWW server 30 (procedure (7)).

In the WWW server 30 having received the encrypted secret key, the secret key is decrypted by a decrypting technique specific to the insurer (procedure (8)). Further, the transactional information temporarily stored by the thus decrypted secret key is encrypted (procedure (9)). The thus encrypted transactional information is preserved in a file 38, in a manner related to the date and the time (procedure (10)).

Note, a completion-judging step, a completion-judging function and completion-judging means are realized by the processing of the procedure (3). An encrypting step, an encrypting function and encrypting means are realized by the processing of the procedure (9). A preserving step, a preserving function and preserving means are realized by the processing of the procedure (10).

In this way, when a completion keyword indicative of the completion of the transactional negotiation is found in the transactional information to be transferred between the transaction-involved parties, the transactional information is encrypted by the secret key generated based on the date and the time at that moment. Further, the encrypted transactional information is preserved into the file 38 of the WWW server 30, in the state related to the date and the time at that moment. These consecutive procedures are automatically executed by the proof collecting program 110 distributed from the insurance server 40, so that the transaction-involved party is noway involved in collecting proof for proving an accident.

In case of the occurrence of accident in a transaction in the electronic commerce, the transaction-involved party sends a proof sending request to the WWW server 30 while specifying the name of the transaction-involved party and the date of the accident occurrence (procedure (11)). In the WWW server 30 having received the proof sending request, the file 38 preserving the encrypted transactional information is retrieved based on the specified name and the specified date of the accident occurrence, and a list of corresponding transactional information is sent to the client 20 (procedure (12)). In the client 20 having received the list, the transactional information as required as the proof is selected, and the selection result is sent to the WWW server 30 (procedure (13)). In the WWW server 30 having received the selection result, the selected transactional information is taken out from the file 38 and sent to the insurance server 40 (procedure (14)).

In the insurance server 40 having received the encrypted transactional information, the corresponding secret key is taken out from the database 46 based on the date and the time of the accident occurrence (procedure (15)), and the transactional information is decrypted by the thus taken out secret key (procedure (16)). Further, the thus decrypted transactional information is utilized as the proof data concerning the insurance benefit payment application.

Thus, similarly to the embodiment shown in FIG. 16, the occurrence of accident can be objectively proven such that the loss caused in a transaction in the electronic commerce can be compensated for by the insurance to thereby protect the transaction-involved party.

By recording a program for realizing such functions into a computer-readable recording medium such as a magnetic tape, magnetic disk, magnetic drum, IC card, CD-ROM, and DVD-ROM, the insurance task processing program according to the present invention can be distributed into the market. Further, those who have obtained such a recording medium are possible to readily constitute the insurance task processing system according to the present invention, making use of a general computer system.

Moreover, by registering the insurance task processing program according to the present invention on a server connected to the Internet, the insurance task processing system according to the present invention can be readily constructed by downloading such a program via telecommunications lines.

What we claimed is:

1. An insurance task processing method comprising:
a solicitation-judging step for monitoring electronic information distributed within a computer network to judge whether or not a solicitation-related keyword as a clue of solicitation-to-insurance is included in said electronic information; and
a distributing step for distributing solicitation-to-insurance information to at least one of involved parties having exchanged the electronic information with each other, when said solicitation-related keyword is judged to be included in the electronic information.

2. An insurance task processing method of claim 1,
wherein said distributing step distributes the solicitation-to-insurance information to the involved party when the involved party has not yet subscribed to insurance.

3. An insurance task processing method of claim 2,
wherein said distributing step distributes the solicitation-to-insurance information to the involved party even when the involved party has already subscribed to insurance, if the insurance is invalid, or if the involved party has experienced an encounter with an accident related to the electronic commerce in the past.

4. An insurance task processing method of claim 1,
wherein said distributing step distributes the solicitation-to-insurance information from an insurer selected corresponding to the contents of the electronic information.

5. An insurance task processing method of claim 1, further comprising:
an insurance premium information receiving step for receiving insurance premium information which has been calculated corresponding to the trading price included in the electronic information, based on a discount insurance premium rate as reduced from a normal insurance premium rate;
a sum calculating step for calculating the sum of the insurance premium indicated by the received insurance premium information and the trading price; and
a presenting step for presenting the calculated insurance premium and the calculated sum to both of the involved parties.

6. An insurance task processing method, comprising:
an input step for inputting transactional information in a transaction related to the electronic commerce;
a transmitting step for transmitting the input transactional information; and
a receiving step for receiving solicitation-to-insurance information transmitted from a server of an insurer, when a solicitation-related keyword as a clue of solicitation-to-insurance is included in said transmitted transactional information.

7. An insurance task processing method of claim 6, further comprising:
a transaction judging step for judging whether or not a transactional keyword has been included in said input transactional information; and
a risk notifying step for notifying a risk related to the electronic commerce, when said transactional keyword is judged to be included in the transactional information.

8. An insurance task processing program for rendering a computer to realize:
a solicitation-judging function for monitoring electronic information distributed within a computer network to judge whether or not a solicitation-related keyword as a clue of solicitation-to-insurance is included in said electronic information; and
a distributing function for distributing solicitation-to-insurance information to at least one of involved parties having exchanged the electronic information with each other, when said solicitation-related keyword is judged to be included in the electronic information.

9. An insurance task processing program for rendering a computer to realize:
an input function for inputting transactional information in a transaction related to the electronic commerce;
a transmitting function for transmitting said input transactional information; and
a receiving function for receiving solicitation-to-insurance information transmitted from a server of an insurer, when a solicitation-related keyword as a clue of solicitation-to-insurance is included in said transmitted transactional information.

10. A computer-readable recording medium recorded with an insurance task processing program for rendering a computer to realize:
a solicitation-judging function for monitoring electronic information distributed within a computer network to judge whether or not a solicitation-related keyword as a clue of solicitation-to-insurance is included in said electronic information; and
a distributing function for distributing solicitation-to-insurance information to at least one of involved parties having exchanged the electronic information with each other, when said solicitation-related keyword is judged to be included in the electronic information.

11. An insurance task processing system comprising:
solicitation-judging means for monitoring electronic information distributed within a computer network to judge whether or not a solicitation-related keyword as a clue of solicitation-to-insurance is included in said electronic information; and
distributing means for distributing solicitation-to-insurance information to at least one of involved parties having exchanged the electronic information with each other, when said solicitation-related keyword is judged to be included in the electronic information.

12. An insurance task processing system comprising:
input means for inputting transactional information in a transaction related to the electronic commerce;
transmitting means for transmitting said input transactional information; and
receiving means for receiving solicitation-to-insurance information transmitted from a server of an insurer, when a solicitation-related keyword as a clue of solicitation-to-insurance is included in said transmitted transactional information.

13. An insurance task processing method comprising:
a completion-judging step for monitoring electronic information distributed within a computer network to judge whether or not a completion keyword indicative of the completion of a transactional negotiation in the electronic commerce is included in said electronic information;
an encrypting step for encrypting the transactional information related to the electronic commerce making use of a secret key, when said completion keyword is judged to be included in the electronic information; and
a preserving step for preserving the encrypted electronic information.

14. An insurance task processing method of claim 13,
wherein said secret key is generated based on the date and the time at the moment when the completion keyword is judged to be included in the transactional information.

15. An insurance task processing method of claim 13,
wherein said secret key is generated by an insurer of an insurance, to which an involved party having exchanged the electronic information has subscribed.

16. An insurance task processing method of claim 15,
wherein said secret key is distributed from the insurer in an encrypted state.

17. An insurance task processing program for rendering a computer to realize:
a completion-judging function for monitoring electronic information distributed within a computer network to judge whether or not a completion keyword indicative of the completion of a transactional negotiation in the electronic commerce is included in said electronic information;
an encrypting function for encrypting the transactional information related to the electronic commerce making use of a secret key, when said completion keyword is judged to be included in the electronic information; and
a preserving function for preserving the encrypted electronic information.

18. A computer-readable recording medium recorded with an insurance task processing program for rendering a computer to realize:
a completion-judging function for monitoring electronic information distributed within a computer network to judge whether or not a completion keyword indicative of the completion of a transactional negotiation in the electronic commerce is included in said electronic information;
an encrypting function for encrypting the transactional information related to the electronic commerce making use of a secret key, when said completion keyword is judged to be included in the electronic information; and
a preserving function for preserving the encrypted electronic information.

19. An insurance task processing system comprising:
completion-judging means for monitoring electronic information distributed within a computer network to judge whether or not a completion keyword indicative of the completion of a transactional negotiation in the electronic commerce is included in said electronic information;
encrypting means for encrypting the transactional information related to the electronic commerce making use of a secret key, when said completion keyword is judged to be included in the electronic information; and
preserving means for preserving the encrypted electronic information.
